(19) United States
(12) Patent Application Publication
(10) Pub. No.: US 2024/0083281 A1
(43) Pub. Date: Mar. 14, 2024

(54) DEVICE FOR AN ELECTRIC VEHICLE, ELECTRIC VEHICLE HAVING A DEVICE, AND METHOD FOR PROVIDING CHARGING ENERGY

(71) Applicant: ZF FRIEDRICHSHAFEN AG, FRIEDRICHSHAFEN (DE)

(72) Inventors: Frank SEEMANN, Euerbach (DE); Andre EHRSAM, Bergrheinfeld (DE); Martin MACH, Plzen 3 (CZ); Zbynek STEPAN, Plzen 3 (CZ); Vladimir DVORAK, Plzen 3 (CZ); Gabriel SCHERER, Deggenhausertal (DE); Matthias ENGICHT, Markdorf (DE)

(21) Appl. No.: 18/273,076

(22) PCT Filed: Jan. 17, 2022
(86) PCT No.: PCT/EP2022/050841

§ 371 Date: Jul. 19, 2023

(30) Foreign Application Priority Data
Jan. 20, 2021 (DE) 10 2021 200 472.5

(51) Int. Cl. B60L 53/57; B60L 53/22; B60L 53/53; B60L 53/63

(52) U.S. Cl. CPC B60L 53/57; B60L 53/22; B60L 53/53; B60L 53/63; B60L 58/12; B60L 2210/42

(57) ABSTRACT

An apparatus for an electric vehicle having a battery interface, an inverter, a switch device and a control device. The inverter has a first terminal for connecting the inverter to the battery interface and a second terminal for connecting the inverter to a switch terminal. The inverter is formed to convert a DC voltage applied to the first terminal into an AC voltage and to provide the latter to the second terminal. The switch device has the switch terminal that connects the switch device to the second terminal and an energization interface for energizing a further electric vehicle coupled to the energization interface.

### CROSS REFERENCE TO RELATED APPLICATIONS

This is a U.S. national stage of Application No. PCT/EP2022/050841 filed Jan. 17, 2022. Priority is claimed on German Application No. DE 10 2021 200 472.5 filed Jan. 20, 2021, the content of which is incorporated herein by reference.

### BACKGROUND OF THE INVENTION

### 1. Field of the Invention

The present disclosure relates to an apparatus for an electric vehicle, an electric vehicle with an apparatus, and a method for providing a charging energy.

### 2. Description of the Related Art

Electrified vehicles are becoming increasingly important industrially for their environmental friendliness. The goal is for not only passenger vehicles but also utility vehicles to be driven electrically.

### SUMMARY OF THE INVENTION

One aspect of the present invention provides an improved apparatus for an electric vehicle, an electric vehicle with an improved apparatus and an improved method for providing a charging energy. Advantageous configurations will be apparent from the following description.

The advantages which are achievable with the suggested solution consist in that a possibility is provided by an apparatus received in an electric vehicle for a further electric vehicle to be provided with electrical energy of the electric vehicle.

An apparatus for an electric vehicle is suggested. The apparatus is usable for providing a charging energy for a further electric vehicle and has a battery interface, an inverter, a switch device and a control device. The battery interface is formed to connect the apparatus to a vehicle battery of the electric vehicle. The inverter has a first terminal for connecting the inverter to the battery interface and a second terminal for connecting the inverter to a switch terminal. The inverter is formed to convert a DC voltage applied to the first terminal into an AC voltage and to provide the latter to the second terminal. The switch device has the switch terminal that connects the switch device to the second terminal and an energization interface for energizing the further electric vehicle coupled to the energization interface. The control device is formed to send an activation signal to the switch device when a limit signal indicates no limit and not to send the activation signal when the limit signal indicates a limit. The activation signal is formed to connect the switch terminal to the energization interface in order to provide charging energy to the energization interface.

The electric vehicle and the further electric vehicle can both be implemented as an electrified utility vehicle, for example, as a truck. At least the further electric vehicle can also be a passenger motor vehicle. The apparatus can serve to provide electrical energy of the vehicle battery of the electric vehicle for the further electric vehicle which, for example, needs electrical energy. The charging energy can serve to charge a further vehicle battery of the further electric vehicle. The limit signal can advantageously serve to limit an amount of charging energy. Accordingly, depending on the limit signal, the charging energy can either be provided when the activation signal is sent or not provided when the activation signal is not sent. The limit signal can prevent an unlimited amount of charging energy being made available for the further electric vehicle. Accordingly, for example, the vehicle battery of the electric vehicle can be prevented from discharging extensively or completely. The inverter can be formed to convert the DC voltage applied to the first terminal into the AC voltage and provide the AC voltage to the second terminal in response to an inverter signal or automatically when a DC voltage is applied to the inverter. Thanks to the apparatus, an electric vehicle can provide another electric vehicle with electrical energy in order to save a long trip to a charging station, for example.

The control device can be formed to determine the limit signal using a charge state signal which represents a battery charge state of the vehicle battery. Accordingly, the charging energy can be provided, or not, depending on the battery charge state. When the charge state signal merely indicates a low battery charge state, for example, the limit signal can indicate the limit in order to spare the vehicle battery which already has a low charge.

For example, the control device can be formed to determine the limit signal that indicates no limit when the charge state signal represents a battery charge state of the vehicle battery above a defined minimum charge state. Accordingly, the charging energy can be provided, for example, until the battery charge state reaches the minimum charge state. In this way, it can be ensured that sufficient electrical energy is available for the electric vehicle's own operation.

It is further advantageous when the control device is formed according to an embodiment form to determine the limit signal indicating the limit when the charge state signal represents a battery charge state of the vehicle battery below a defined minimum charge state. Accordingly, the charging energy can be stopped, for example, as soon as the battery charge state reaches or falls below the minimum charge state. This can prevent an excessive discharging of the vehicle battery.

According to one aspect, the control device can be formed to determine the minimum charge state depending on an expected demand on the vehicle battery as result of a further operation of the electric vehicle. Further trips and/or operating processes for onboard auxiliary drives of the electric vehicle and/or charging processes for additional electric vehicles or devices can be provided for the further operation, for example. Accordingly, the minimum charge state can be determined in such a way that the electric vehicle can be further operated in accordance with its expected usage without having too little electrical energy available even after the further electric vehicle is charged.

The control device can be formed to determine the limit signal depending on a comparison between an amount signal that represents a defined maximum amount of charging energy and a charge signal that represents an amount of charging energy that is delivered. The charging energy for the further vehicle can also be advantageously limited based on a defined maximum amount. The control device can be formed to determine the limit signal indicating the limit when the delivered amount of charging energy corresponds to the defined maximum amount. Accordingly, the charging energy can be stopped after the defined maximum amount has been reached. The control device may further be formed to determine the limit signal indicating no limit when the amount of charging energy delivered is less than the defined maximum amount. Accordingly, the charging energy can continue to be provided until, for example, the defined maximum amount is reached. This provides an opportunity to determine the amount of energy provided by the electric vehicle to the further electric vehicle. Under some circumstances, the charging process can be aborted before the further vehicle battery has been completely charged. This can be useful in order not to jeopardize the further operation of the electric vehicle or to enable charging of further electric vehicles.

For example, the control device can be formed to load the amount signal from a storage device. The storage device can be arranged inside of or external to the apparatus. Correspondingly, the control device can be formed to load the amount signal wirelessly or wired from the storage device. A value of the amount signal can be stored in the storage device to be fixed or adjustable automatically or via a user interface.

The switch device can have a first switch for connecting the switch terminal to the energization interface. The electrical energy can advantageously be conducted by the switch by producing an electrical connection by the shortest path through the switch device to the energization interface. Further, the energization interface can be decoupled from the inverter using the first switch, for example, in order to prevent unauthorized charging of the further electric vehicle.

The switch device can be formed to close the first switch using the activation signal. In this way, electrical energy can advantageously be conducted through the switch device in order to provide the charging energy to the energization interface.

The switch device may further comprise a charge interface for feeding further electrical energy into the apparatus. Additionally or alternatively, the switch device can have an auxiliary interface for connecting the apparatus to an auxiliary drive. The control device can be formed to provide an inverter signal in order to convert a DC voltage applied to the first terminal into an AC voltage and to provide the latter to the second terminal. Additionally or alternatively, the control device can be formed to provide a further inverter signal in order to convert an AC voltage applied to the charge interface into a DC voltage and to provide the latter to the first terminal. The inverter can accordingly be formed as a bidirectional inverter. The auxiliary drive can be formed, for example, to provide a functionality going beyond a locomotion of the electric vehicle. For example, the auxiliary drive can be used to drive an excavator bucket or a crane of the electric vehicle. For example, the switch device can have a plurality of switches which can be opened and closed, for example, depending on a desired function, in order, for example, to electrically connect the auxiliary drive and/or the charge interface to the battery interface. For example, an auxiliary function of the electric vehicle, such as driving the crane, can be achieved via the auxiliary drive. For example, the vehicle battery can be charged via the charge interface.

An electric vehicle has an apparatus formed in one of the variants described above and has the vehicle battery connected to the battery interface. The electric vehicle can be realized as an electrified utility vehicle, for example, as a truck. The electric vehicle may further have the auxiliary drive connected to the auxiliary interface.

Further, a method is suggested for providing a charging energy for a further electric vehicle. The method is usable by the above-described electric vehicle with the apparatus in one of the variants described above and has a conversion step, a connection step and a disconnection step. In the conversion step, a DC voltage applied to the first terminal is converted into an AC voltage, and the AC voltage is provided at the second terminal. In the connection step, the switch terminal is connected to the second terminal and the energization interface using the activation signal which is emitted when a limit signal indicates no limit in order to provide the charging energy to the energization interface for the further electric vehicle. In the disconnection step, the switch terminal is disconnected from the second terminal and the energization interface when the limit signal indicates a limit so that no charging energy is provided to the energization interface for the further electric vehicle.

This method may be implemented, for example, via software or hardware or in a combination of software and hardware, for example, in a control device.

### BRIEF DESCRIPTION OF THE DRAWINGS

Exemplary embodiments of the solution suggested herein are shown in the drawings and described more fully in the following description. The drawings show:

FIG. 1 is a schematic depiction of an electric vehicle;

FIG. 2 is a schematic depiction of an apparatus for providing a charging energy for a further electric vehicle; and

FIG. 3 is a flowchart of a method for providing a charging energy for a further electric vehicle.

### DETAILED DESCRIPTION OF THE PRESENTLY PREFERRED EMBODIMENTS

In the following description of preferred aspects of the present invention, similarly operating elements depicted in the various figures are provided with identical or like reference numerals so as to avoid repetitive description of these elements.

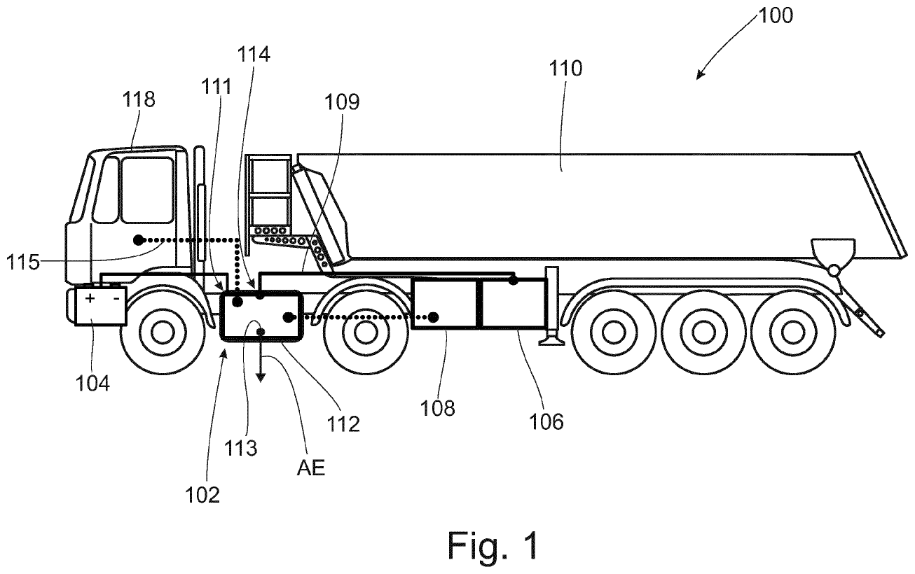

FIG. 1 shows a schematic view of an electric vehicle 100 according to an aspect of the invention. The electric vehicle 100 is realized, for example, as an electrified truck, for example, with a grain crusher or a concrete pump. The electric vehicle 100 has an apparatus 102 and a vehicle battery 104 and, merely optionally, an auxiliary drive 106 and/or a hydraulic device 108. The apparatus 102 is formed to provide a charging energy AE for a further electric vehicle. Further, according to one aspect, the apparatus 102 is optionally formed to provide an operating energy 109 for the auxiliary drive 106. According to one aspect, the auxiliary drive 106 is formed to drive or move the hydraulic device 108. The hydraulic device 108 is formed according to one aspect as a hydraulic pump which acts upon a hydraulic system with pressure, for example, for moving a vehicle body 110 of the electric vehicle 100. According to one aspect, the vehicle battery 104 is formed to provide a drive energy for a drive for locomotion of the electric vehicle 100.

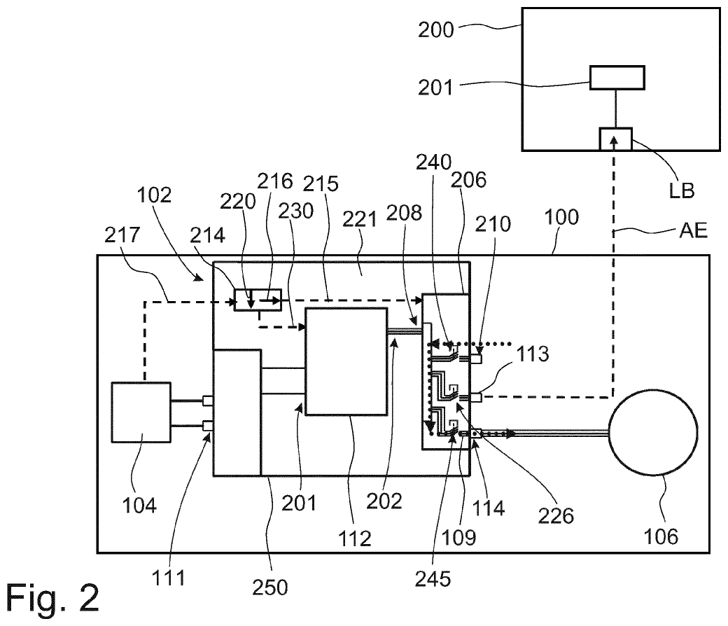

The apparatus 102, which is shown in more detail in FIG. 2, has a battery interface 111 formed to connect the apparatus 102 to the vehicle battery 104. Further, the apparatus 102 has an inverter 112 that has a first terminal, not shown, and a second terminal. The inverter 112 is connected to the battery interface 111 by the first terminal and is connected to a switch terminal by the second terminal. The inverter 112 is optionally implemented to be bidirectional. The inverter 112 is formed to convert a DC voltage applied to the first terminal into an AC voltage and to provide the latter at the second terminal. The conversion is initiated in response to an inverter signal or automatically when the DC voltage is present at the first terminal. The apparatus 102 likewise has a switch device, not shown, with the switch terminal and an energization interface 113 for energizing the further electric vehicle coupled with the energization interface 113. The switch device according to one aspect has an auxiliary interface 114 and/or a charge interface, although this is merely optional. The apparatus 102 further has a control device, not shown. As will be described more fully referring to FIG. 2, the control device is formed to send an activation signal to the switch device when a limit signal indicates no limit and does not send the activation signal when the limit signal indicates a limit. The activation signal is configured to connect the switch terminal to the energization interface in order to provide the charging energy AE at the energization interface 113.

The switch terminal is formed to connect the second terminal of the inverter 112 to the switch device. The apparatus 102 according to one aspect is connected to the auxiliary drive 106 via the auxiliary interface 114. The charge interface is formed to feed a further electrical energy into the apparatus 102. According to this embodiment example, it is possible, for example, for a driver of the electric vehicle 100 to provide an operator signal 115 using an operator device proceeding from a driver's cab 118 of the electric vehicle 100, which operator signal 115 can be used by the control device of the apparatus 102 to control the inverter 112 and/or the switch device.

The transition to electrically driven utility vehicles, referred to herein as electric vehicle 100, has engendered possibilities for power takeoffs. Builders who create work functions require a new interface, for instance, to operate the superstructures. According to one aspect, the battery interface 111 is used as a new interface to the vehicle battery 104. In order to remove energy from the vehicle battery 104 and provide it to a further electric vehicle as charging energy AE and/or, for example, to operate a three-phase motor, referred to in this instance as auxiliary drive 106, the inverter 112 is necessary. According to this aspect, stationary work functions of the electric vehicle 100 relating, for example, to cranes, concrete pumps, work platforms or grain crushers, can be carried out by the auxiliary drive 106. With this in mind, a multifunctional apparatus 102 is suggested whose main function is to draw energy from the vehicle battery 104 in order to charge a further vehicle battery of a further electric vehicle. A secondary function of the apparatus 102 according to this aspect is to convert the electrical energy into various other forms of electrical energy in order to power drives, such as the auxiliary drive 106, for example, and/or to charge and protect the vehicle battery 104 via the charge interface. Mechanical devices, hydraulic devices 108 or pneumatic devices, for example, are controllable by the auxiliary drive 106.

In other words, with this in mind, an electrified utility vehicle is described that has a multifunctional inverter, described here as apparatus 102, and is formed to charge other vehicles. The apparatus 102 is optionally used to operate at least one work function of the electric vehicle 100. For example, the apparatus 102 makes it possible to implement the work function, that is, driving the auxiliary drive 106, and optionally a charging function by which the vehicle battery 104, for example, is charged.

Also optionally, an auxiliary function of providing a locally delimited electrical grid in the form of a microgrid, for example, for 230V/400V is made possible. According to one aspect, by connecting the charge interface, for example, to a power source and the auxiliary interface 114, the further electrical energy is supplied directly to the auxiliary drive 106 realized as electric motor, for example, by the power source without the vehicle battery 104, also referred to as battery system, being required.

According to one aspect, for a boost function, additional boost energy is drawn from the vehicle battery 104 parallel to the control of the auxiliary drive 106 by the charge interface and is provided for the auxiliary drive 106. To this end, the inverter 112 is formed to be synchronized to the grid. A voltage value of the DC voltage applied to the first terminal is variable according to this embodiment example.

FIG. 2 shows a schematic view of an apparatus 102 for providing a charging energy AE for a further electric vehicle 200 according to an embodiment example. The apparatus 102 shown here can correspond to or is at least similar to the apparatus 102 described in FIG. 1 and is accordingly used or usable in an electric vehicle 100 such as that described in FIG. 1.

According to this aspect, the energization interface 113 is electrically connected to a charging socket LB of the further electric vehicle 200, for example, via a connecting cable and/or a plug-in connection, for providing the charging energy AE for the further electric vehicle 200. According to one aspect, the charging socket LB is formed to receive a plug for feeding three-phase alternating current. A further vehicle battery 201 of the further electric vehicle 200 can be charged via the charging socket LB.

Accordingly, the apparatus 102 installed in the electric vehicle 100 can be used to charge the further vehicle battery 201 of the further electric vehicle 200 using the energy provided by the vehicle battery 104 of the electric vehicle 100.

FIG. 2 further shows the battery interface 111, the inverter 112 with the first terminal 201 and the second terminal 202 as well as the switch device 206 with the switch terminal 208, the energization interface 113 and the optional auxiliary interface 114 and the optional charge interface 210. Further, the control device 214 is shown.

According to this aspect, the battery interface 111 is electrically connected to the vehicle battery 104 of the electric vehicle 100. According to this embodiment example, the first terminal 201 is electrically connected to the battery interface 111 and the second terminal 202 is electrically connected to the switch terminal 208.

The control device 214 is formed to send the activation signal 215 to the switch device 206 when the limit signal 216 indicates no limit and not to send the activation signal 215 when the limit signal 216 indicates a limit. The activation signal 215 is formed to connect the switch terminal 208 to the energization interface 113 in order to provide the charging energy AE to the energization interface 113. According to one aspect, the inverter 112 is formed to convert the DC voltage provided by the vehicle battery 104 into a three-phase AC voltage which can then be provided to the energization interface 113 via the switch device 206.

According to one aspect, the apparatus 102 serves to provide electrical energy of the vehicle battery 104 of the electric vehicle 100 for the further electric vehicle 200 which, for example, requires electrical energy. According one aspect, the charging energy AE serves to charge the further vehicle battery 201 of the further electric vehicle 200. According to one aspect, the control device 214 is formed to determine the limit signal 216 using a charge state signal 217 representing a battery charge state of the vehicle battery 104. According to one aspect, the control device 214 is formed to determine the limit signal 216 which indicates no limit when the charge state signal 217 represents a battery charge state of the vehicle battery 104 below a defined minimum charge state. According to one aspect, the charging energy AE is provided until the battery charge state reaches the minimum charge state. Subsequently, the supply of charging energy AE is halted in order not to discharge the vehicle battery 104 more than is intended. Correspondingly, the control device 214 according to one aspect is formed to determine the limit signal 216 indicating the limit when the charge state signal 217 represents a battery charge state of the vehicle battery 104 below the defined minimum charge state. The charging energy AE according to one aspect is stopped as soon as the battery charge state reaches or falls below the minimum charge state in order, for example, to prevent excessive discharging of the vehicle battery 104. According to one aspect, the battery charge state of the vehicle battery 104 is detected and provided using a suitable measuring device.

According to one aspect, the control device 214 is formed to determine the minimum charge state depending on an expected demand on the vehicle battery 104 as result of a further operation of the electric vehicle 100. Further trips and/or operating processes for onboard auxiliary drives 106 of the electric vehicle 100 and/or charging processes for additional electric vehicles or devices are provided, for example, for the further operation. For example, an amount of energy corresponding to the expected usage is estimated using an estimating device and is used for determining the minimum charge state. Information about the expected demand is provided, for example, automatically or by user input via an operator control interface.

According to one aspect, the control device 214 is formed to load the minimum charge state from a storage device. A value of the minimum charge state can be stored in the storage device to be fixed or adjustable. For example, the value of the minimum charge state can be adapted when updated information about the expected demand leads to a change in the minimum charge state. The storage device can be arranged internal to or external to the apparatus 102. Correspondingly, the control device 214 can be formed to load the minimum charge state in the form of the signal wirelessly or wired from the storage device.

According to a further aspect, the control device 214 is formed to determine the limit signal 216 depending on a comparison of an amount signal 220 representing a defined maximum amount of charging energy AE and a charge signal 221 representing an amount of charging energy AE that is delivered. According to one aspect, the control device 214 is formed to determine the limit signal 216 indicating the limit when the delivered amount of charging energy AE corresponds to the defined maximum amount. Further, according to an embodiment example, the control device 214 is formed to determine the limit signal 216 indicating no limit when the delivered amount of charging energy AE is less than the defined maximum amount. According to one aspect, the charging energy AE is provided until, for example, the defined maximum amount is reached and/or the charging energy AE is stopped after reaching the defined maximum amount. According to one aspect, the control device 214 is formed to load the amount signal 220 from a storage device. The storage device can be arranged internal to the apparatus or external to the apparatus 102. Correspondingly, the control device 214 can be formed to load the amount signal 210 from the storage device wirelessly or wired. A value of the defined maximum amount can be stored in the storage device to be fixed or adjustable automatically or via a user interface.

The switch device 206 according one aspect has a first switch 226 for connecting the switch terminal 208 to the energization interface 113. The switch device 206 according to one aspect is formed to close the first switch 226 using the activation signal 215 in order to provide the charging energy AE to the energization interface 113. Further, the switch device 206 according to this embodiment example is formed to open the first switch 226 in the absence of activation signal 215 so that no charging energy AE is provided to the energization interface 113. According to one aspect, the control device 214 is formed to emit a deactivation signal which is configured to open the first switch 226 so that the charging energy AE is not provided to the energization interface 113 when the limit signal 216 indicates the limit. Accordingly, release of charging energy AE can be controlled using the switch device 206.

The switch device 206 according to one aspect further has the charge interface 210 for feeding further electrical energy 227 into the apparatus 102 and/or the auxiliary interface 114 for connecting the apparatus 102 to the auxiliary drive 106. The control device 214 is formed to provide an inverter signal 230 in order to convert a DC voltage applied to the first terminal 201 into an AC voltage and to provide the latter to the second terminal 202 and/or to provide a further inverter signal 235 in order to convert an AC voltage applied to the charge interface 210 into a DC voltage and to provide the latter to the first terminal 201.

Further, the switch device 206 according to one aspect has a second switch 240 and a third switch 245 which, depending on a desired function, for example, can be closed using the activation signal 215 or another signal and opened using a further other signal in order, for example, to electrically connect the auxiliary drive 106 and/or the charge interface 210 to the battery interface 111. According to one aspect, an auxiliary function of the electric vehicle 100, such as driving the crane, is accomplished via the auxiliary drive 106. Optionally, the inverter 112, the switch device 206 and the control device 214 are arranged in a common housing 250.

The suggested apparatus 102 which can also be referred to as a multifunctional inverter unit or PDU for short, realizes the function of a converter of electrical energy into other forms of electrical energy. According to one aspect, the apparatus 102 is usable as power supplier for the auxiliary drive 106 that can be a three-phase motor. Further, the apparatus 102 according to one aspect is usable to carry out an AC voltage charging process for the vehicle battery 104. Further, according to one aspect, the vehicle battery 104 is protected using the apparatus 102. According to one aspect, the apparatus 102 further serves as a monitoring system and enables an energy management. According to one aspect, the apparatus 102 makes possible a power grid. According to one aspect, the apparatus 102 serves as connection interface to vehicle functions, for example, a driver assist system (ADAS).

According to one aspect for a silo consolidator or a conveyor screw, the optional auxiliary drive 106, which may also be referred to as “power to work application” or PTO drive for short, realizes the function of converting electrical energy into mechanical energy. According to one aspect, the auxiliary drive 106 for a dump truck or crane realizes the function of converting electrical energy into hydraulic energy. According to one aspect, the auxiliary drive 106 for an air compressor realizes the function of converting electrical energy into pneumatic energy.

Electrically driving utility vehicles, such as the electric vehicle 100 or further electric vehicle 200 shown here, generally have battery sizes which are adapted to their work use. The vehicle battery 104 is selected no larger than necessary because it is very expensive. Under extraordinary boundary conditions, such as low temperatures or other boundary conditions demanding more power from the electric vehicle 100 or further electric vehicle 200, the battery capacity of the respective battery might not be sufficient for a work cycle, for example, a shift, and it is necessary to charge the battery intermediately. A charging station must be within reach for this purpose. Since many special utility vehicles are used in rural areas, availability could be problematic because of the low density of charging stations in these areas.

The suggested apparatus 102 advantageously makes it possible that when a vehicle, in this instance, the further electric vehicle 200, has a battery capacity, which is too low and cannot reach the next charging station or would have to interrupt its work, another vehicle, in this instance, the electric vehicle 100, with surplus battery capacity charges the further electric vehicle 200. The multifunctional inverter is accordingly usable to charge other vehicles in a vehicle-to-vehicle charging process. According to one aspect, the amount of energy provided by the electric vehicle 100 to the further electric vehicle 200 is limited via software.

In an application example, a work function of the electric vehicle 100 is operated using the apparatus 102 by utilizing the auxiliary drive 106, for example, the vehicle battery 104 is charged via the charge interface 210 and/or a microgrid is constructed. The apparatus 102 additionally has the function of charging other vehicles, such as the further electric vehicle 200, via the energization interface 113 (alternating current) and this can also be controlled/regulated by the control device 214.

According to one aspect, the energization interface 113 is formed to provide the charging energy AE of 400 VAC to 600 VAC within a tolerance range of 15% deviation, for example, within a tolerance range of 10% deviation in a frequency range of 50 Hz to 60 Hz. According to one aspect, the energization interface 113 is formed to provide the charging energy AE of 230 VAC within a tolerance range of 15% deviation, for example, within a tolerance range of 10% deviation in a frequency range of 50 Hz to 60 Hz. According to one aspect, the charge interface 210 has a further charging socket which is formed to receive a plug for feeding three-phase alternating current.

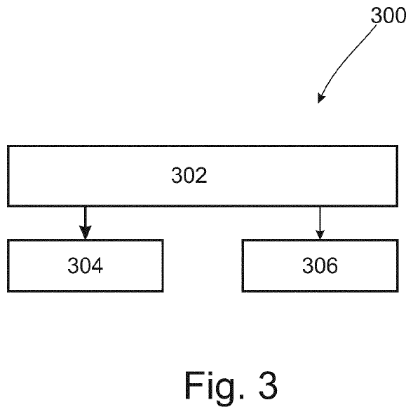

FIG. 3 shows a flowchart for a method 300 for providing a charging energy for a further electric vehicle according to an embodiment example.

The method 300 is usable by the electric vehicle described in FIG. 1 or FIG. 2 with the apparatus in a variant described in FIG. 1 or FIG. 2 and has a step 302 for converting, a step 304 for connecting and a step 306 for disconnecting. In the conversion step 302, a DC voltage applied to the first terminal is converted into an AC voltage, and the AC voltage is provided to the second terminal. In the connection step 304, the switch terminal is connected to the second terminal and the energization interface using the activation signal which is emitted when a limit signal indicates no limit in order to provide the charging energy to the energization interface for the further electric vehicle. In the disconnection step 306, the switch terminal is disconnected from the second terminal and the energization interface when the limit signal indicates a limit so that no charging energy is provided to the energization interface for the further electric vehicle.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-12. (canceled)

13. An apparatus for an electric vehicle, configured to provide a charging energy for a further electric vehicle comprising:
a battery interface configured to connect the apparatus to a vehicle battery of the electric vehicle;
an inverter with a first terminal configured to connect the inverter to the battery interface and a second terminal configured to connect the inverter to a switch terminal, wherein the inverter is configured to convert a DC voltage applied to the first terminal into an AC voltage and to provide the AC voltage to the second terminal;
a switch device with the switch terminal which connects the switch device to the second terminal and with an energization interface configured to energize the further electric vehicle coupled to the energization interface; and
a control device configured to send an activation signal to the switch device when a limit signal indicates no limit and not to send the activation signal when the limit signal indicates a limit,
wherein the activation signal connects the switch terminal to the energization interface to provide charging energy to the energization interface.

14. The apparatus according to claim 13, wherein the control device determines the limit signal using a charge state signal which represents a battery charge state of the vehicle battery.

15. The apparatus according to claim 14, wherein the control device determines the limit signal which indicates no limit when the charge state signal represents a battery charge state of the vehicle battery above a defined minimum charge state.

16. The apparatus according to claim 15, wherein the control device determines the limit signal indicating the limit when the charge state signal represents a battery charge state of the vehicle battery below a defined minimum charge state.

17. The apparatus according to claim 16, wherein the control device determines the defined minimum charge state depending on an expected demand on the vehicle battery through a further operation of the electric vehicle.

18. The apparatus according to claim 13, wherein the control device determines the limit signal depending on a comparison between an amount signal which represents a defined maximum amount of charging energy and a charge signal which represents an amount of charging energy that is delivered.

19. The apparatus according to claim 18, wherein the control device is configured to load the amount signal from a storage device.

20. The apparatus according to claim 13,
wherein the switch device has a first switch configured to connect the switch terminal to the energization interface, and
wherein the switch device is configured to close the first switch using the activation signal.

21. The apparatus according claim 13, wherein the switch device further comprises a charge interface configured to feed electrical energy into the apparatus and/or an auxiliary interface configured to connect the apparatus to an auxiliary drive, wherein the control device provides an inverter signal to convert a DC voltage applied to the first terminal into an AC voltage and to provide the AC voltage to the second terminal and/or to provide a further inverter signal in order to convert an AC voltage applied to the charge interface into a DC voltage and to provide the DC voltage to the first terminal.

22. An electric vehicle with an apparatus connected to a battery interface configured to provide a charging energy for a further electric vehicle comprising:
the battery interface configured to connect the apparatus to a vehicle battery of the electric vehicle;
an inverter with a first terminal configured to connect the inverter to the battery interface and a second terminal configured to connect the inverter to a switch terminal, wherein the inverter is configured to convert a DC voltage applied to the first terminal into an AC voltage and to provide the AC voltage to the second terminal;
a switch device with the switch terminal which connects the switch device to the second terminal and with an energization interface configured to energize the further electric vehicle coupled to the energization interface; and
a control device configured to send an activation signal to the switch device when a limit signal indicates no limit and not to send the activation signal when the limit signal indicates a limit, wherein the activation signal connects the switch terminal to the energization interface to provide charging energy to the energization interface.

23. A method for providing a charging energy for a further electric vehicle, with an apparatus configured to provide a charging energy for a further electric vehicle having a battery interface configured to connect the apparatus to a vehicle battery of an electric vehicle, an inverter with a first terminal configured to connect the inverter to the battery interface and a second terminal configured to connect the inverter to a switch terminal, wherein the inverter is configured to convert a DC voltage applied to the first terminal into an AC voltage and to provide the AC voltage to the second terminal, a switch device with the switch terminal which connects the switch device to the second terminal and with an energization interface configured to energize the further electric vehicle coupled to the energization interface, and a control device configured to send an activation signal to the switch device when a limit signal indicates no limit and not to send the activation signal when the limit signal indicates a limit, wherein the activation signal connects the switch terminal to the energization interface to provide charging energy to the energization interface, the method comprising:
converting a DC voltage applied to the first terminal into an AC voltage and providing the AC voltage to the second terminal;
connecting the switch terminal to the second terminal and the energization interface using the activation signal which is emitted when a limit signal indicates no limit in order to provide the charging energy to the energization interface for the further electric vehicle; and
disconnecting the switch terminal from the second terminal and the energization interface when the limit signal indicates a limit so that no charging energy is provided to the energization interface for the further electric vehicle.
